(19) United States
(12) Patent Application Publication
(10) Pub. No.: US 2025/0147538 A1
(43) Pub. Date: May 8, 2025

(54) Setting Device for Sensing a Driving Request for a Motor Vehicle, Motor Vehicle, and Method for Operation

(71) Applicant: Robert Bosch GmbH, Stuttgart (DE)

(72) Inventors: Jonas Rechkemmer, Schweigern (DE); Marcel Bastian, Tamm (DE); Michael Hofmann, Mannheim (DE); Philipp Seibold, Fellbach (DE)

(21) Appl. No.: 18/931,220

(22) Filed: Oct. 30, 2024

(30) Foreign Application Priority Data
Nov. 3, 2023 (DE) 10 2023 210 901.8

(51) Int. Cl. G05G 1/38; G05G 5/03

(52) U.S. Cl. CPC G05G 1/38; G05G 5/03

(57) ABSTRACT

A setting device for sensing a driving request for a motor vehicle having an operating element which can be operated by a driver of the motor vehicle, wherein at least a first sensor is associated with the operating element for sensing actuation acting on the operating element, wherein the operating element is arranged in such a way that it can be moved by a bearing device into different idle positions. It is contemplated that a second sensor is associated with the operating element for sensing a current orientation of the operating element.

This application claims priority under 35 U.S.C. § 119 to application no. DE 10 2023 210 901.8, filed on Nov. 3, 2023 in Germany, the disclosure of which is incorporated herein by reference in its entirety.

The present disclosure relates to a setting device for sensing a driving request for a motor vehicle, with an operating element operable by a driver of the motor vehicle, wherein at least a first sensor for sensing at least one actuation acting on the operating element is associated with the operating element.

Furthermore, the disclosure relates to a motor vehicle with such a setting device as well as to a method for operating the setting device or the motor vehicle.

### BACKGROUND

Conventional motor vehicles typically have a hydraulic braking system that includes a brake pedal that can be actuated by the driver as an operating element and a master brake cylinder mechanically coupled to the brake pedal. By actuating the brake pedal, the master brake cylinder is actuated, or a hydraulic piston in the master brake cylinder is displaced by the brake pedal, thereby generating a hydraulic pressure in the master brake cylinder which is distributed into one or more brake circuits of the brake system. The hydraulic pressure build-up is thus carried out at least in part directly by actuating the brake pedal. In modern motor vehicles, the pressure build-up is supported by a brake booster.

In the case of newer motor vehicles, in particular as electrification of motor vehicles progresses, the plan is to eliminate the mechanical connection between the operating element and the actuator, in particular the master brake cylinder. So-called brake-by-wire braking systems sense the actuation request or the driver request by means of a sensor associated with the operating element and activate one or more actuators as a function of its sensor signal to satisfy the driving request. A corresponding braking system is known from the patent application EP 1 459 928 A2, for example.

In addition, associating a controllable actuator with the operating element, which can provide haptic feedback to the driver when the operating element is actuated, is known. For example, a tactile pulse exerted by the actuator on the operating element which alerts the driver to certain events, such as the use of an ABS brake control, is known.

An adjustable motor vehicle pedal arrangement having an adjustment device and a pedal, wherein the pedal is adjustable in its position and/or orientation by the setting device, is adjustable to the needs of the user or driver, and is lockable in a selected position by the locking device, is also known from patent application DE 10 2012 024 846 A1.

### SUMMARY

The setting device according to the disclosure has the advantage that operation of the operating element can be reliably and precisely sensed, regardless of the orientation or position of the displaceable operating element. According to the present disclosure, it is provided that the operating element is arranged in a displaceable manner by a bearing device in different idle positions and that a second sensor is associated with the operating element for sensing a current orientation of the operating element. By monitoring or sensing the current orientation of the operating element, it is ensured that the orientation or position of the operating element can be reliably determined when identifying the driver request by actuating the operating element. For example, an inclined orientation or inclined position and a thereby reduced actuation force may be compensated for if the inclined position is known. Regardless of the orientation and position of the operating element, the driver request can therefore be implemented precisely and in a comprehensible way at all times for the driver.

Preferably, it is provided that the second sensor is an accelerometer. The accelerometer can be used to determine the orientation and in particular a change in the orientation of the operating element inexpensively and precisely.

Preferably, at least one controllable actuator is associated with the operating element, which can particularly be controlled to perform a verification of the current orientation sensed by the second sensor for exerting a pulse of force on the operating element. The operating element can thereby be excited or moved by means of the actuator, thereby exciting the second sensor, in particular the accelerometer, and thereby enabling the orientation of the operating element to be determined or verified with particular precision. For example, the sensor signal sensed by the sensor is compared with a stored sensor signal determined as a function of a predetermined orientation of the operating element to determine the current orientation of the operating element. Preferably, a plurality of expected sensor signals are stored in a non-volatile memory depending on different orientations of the operating element to be compared to the currently sensed sensor signal of the sensor after the operating element is excited by the actuator, in order to determine the current orientation of the operating element based on the comparison. In particular, a map is stored for this purpose, which is used by an advantageous control unit during the comparison.

Particularly preferably, the actuator is configured as a vibration actuator that does not apply a single but rather a plurality of force pulses to the operating element for its excitation. By controlling the actuator and sensing the sensor signal of the second sensor determined in response thereto, the functionality of the setting device can also be tested in an advantageous manner. Preferably, the above-mentioned control unit is configured to control the actuator and sense the sensor signal to test the functionality of the setting device.

Particularly preferably, the control unit is specifically designed to sense a current orientation of the operating element depending on the sensor signal of the second sensor, when used as intended. In particular, the control unit is specifically designed to control the actuator to perform the orientation detection when used as intended and to evaluate the sensor signal sensed in response to the control, as described above.

It is particularly preferred that the control unit is specifically designed to correct an actuation force sensed by the first sensor or an actuation path sensed by the first sensor as an actuation of the operating element depending an orientation of the operating element sensed by the second sensor when used as intended. As already mentioned above, this is achieved by ensuring reliable sensing of the driver request regardless of the actual orientation of the operating element. The driver can thus optimally adjust the setting device to their ergonomic requirements.

Preferably, the operating element is configured as a foot pedal, in particular a brake pedal, or as a handle that can be activated manually.

Particularly preferably, the control unit is configured to conduct a plausibility check of the orientation of the operating element sensed by the second sensor depending on the sensor signal of at least one further sensor. Particularly preferably, the further sensor is part of the setting device. Optionally, the further sensor is, for example, a sensor rigidly attached to the motor vehicle or attachable to monitor the orientation of the motor vehicle. For this purpose, the further sensor is also configured as an accelerometer or inertial sensor, for example. Alternatively, the control unit is connected to a further sensor of the motor vehicle, which is already provided for monitoring the position and/or orientation of the motor vehicle. In this case, an existing further sensor can then be used and no further sensor needs to be added.

The motor vehicle having features of the disclosure comprises the setting device according to the disclosure. The advantages specified above are achieved as a result.

The method according to the disclosure with features of the disclosure is characterized in that a current orientation of the operating element is determined depending on a sensor signal of the second sensor. This results in the above benefits.

Particularly preferably, a driving request of a driver of the motor vehicle is determined as a function of the determined orientation and a sensor signal of the first sensor. In particular, the process as described above is followed.

### BRIEF DESCRIPTION OF THE DRAWINGS

Further advantages and preferred features and combinations of features result in particular from the previous descriptions and from the disclosure. The disclosure will be explained in more detail below with reference to the drawings. Shown are:

FIG. 1 shows a motor vehicle with an advantageous setting device in a simplified illustration,

FIG. 2 shows an operating element of the setting device in a simplified illustration, and

FIGS. 3A to C, show different orientations of the operating element.

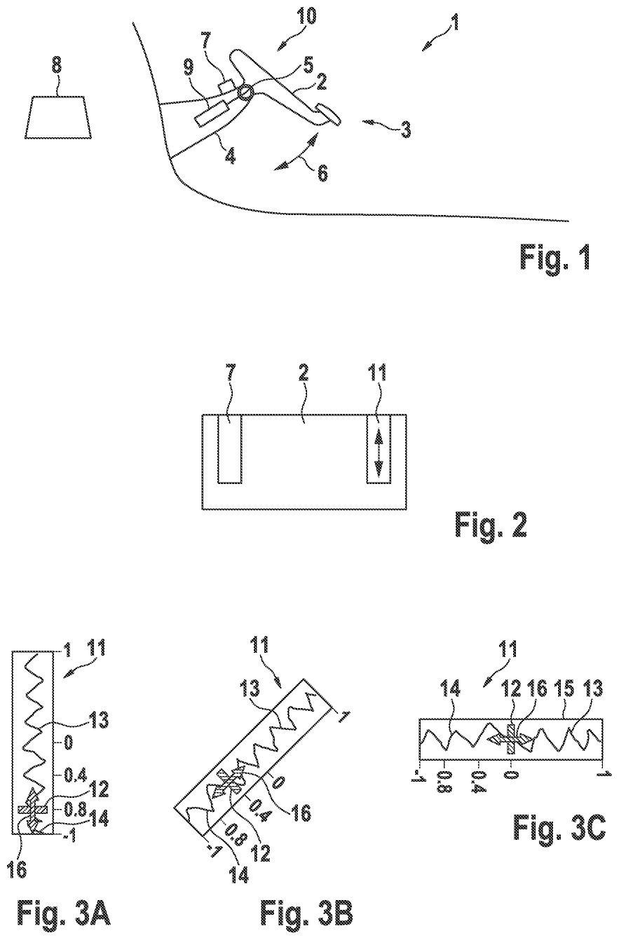

In a simplified illustration, FIG. 1 shows the footwell of a motor vehicle 1, which is not shown in more detail here, in which an operating element 2 of a brake system 3 is arranged. In the present case, the operating element 2 is a brake pedal, alternatively an accelerator pedal, which the driver of the motor vehicle 1 can actuate with his or her foot. Alternatively, the operating element 2 is configured or set up as an accelerator pedal. The brake pedal 2 is held in a displaceable position on a bearing device 4, which is fixed in the foot space, in particular such that can be pivoted about a pivot axis 5 by the driver, as indicated by an arrow 6 in FIG. 1. This allows the operator to adjust the operating element to an orientation that best meets their ergonomic or comfort needs.

A sensor 7 is associated with the operating element 2, by means of which an actuating force acting on the operating element 2 and/or an actuating path set by the actuation of the operating element 2 can be sensed according to arrow 6 of the operating element 2. The sensor 7 can thus monitor an actuation of the brake pedal or the actuation lever 2.

The sensor 7 is at least connected to a control unit 8 by the signal, whereby the control unit monitors and evaluates the sensor signal of the sensor 7 in order to determine a driver request, in particular a braking torque requirement, as a function of a sensed actuating force and/or a sensed actuating path, and to activate at least one actuator of a braking system of the motor vehicle 1 to adjust a braking force, as a function of the determined braking request.

Furthermore, a controllable actuator 9 is associated with the operating element 2. This actuator 9 is also at least connected to the control unit 8 by the signal, and configured to provide haptic feedback to the operating element 2. The actuator 9 is configured and can be controlled to apply a pulse of force to the operating element 2, for example, which can be detected by the driver as the haptic feedback. The control unit 8 is in particular configured to control the actuator 9 to generate a single pulse of force or multiple pulses of force in the manner of a vibration that act on the operating element 2.

At least the operating element 2 and the sensor 7 together form an advantageous setting device 10 for sensing a driver request, in the present case a driver's braking request.

FIG. 2 shows a simplified top view of the operating element 2. In addition to the sensor 7, the operating element 2 is also associated with a further sensor 11, which is configured to sense a current orientation or position of the travel pedal or the brake pedal. In particular, the sensor 11 is arranged and mounted directly on or on top of the operating element 2. The control unit 8 is connected to the sensor 7 and to the sensor 11 to evaluate their sensor signals.

FIGS. 3A to 3C show different orientations of the operating element 2. The sensor 11, which is configured as an accelerometer and shown in a simplified manner, is shown. The sensor 11 comprises a sensor element 12 mounted in a movable manner which lies between two spring elements 13, 14, which are compressed or extended depending on the position of the sensor element 12 and apply a compressive force or pulling force on the sensor element 12, respectively. In a neutral position as shown in FIG. 3C, when the sensor 11 is horizontally aligned, the sensor element 12 is moved by the spring elements 13, 14 to a central position within a housing 15 of the sensor 11. From this neutral position, the sensor element 12 can be viewed in both directions in longitudinal extension of the sensor 11 to be moved the same way. If the sensor 11 is raised, i.e. tilted out of the horizontal position, as shown for example in FIG. 3B, into an inclined position of approximately 45° towards the horizontal, the sensor element 12 is moved by gravity or its weight force contrary to the spring force of the spring element 14 then lying below, and thus moves closer to the lower end of the housing 15. If the sensor 11 is further raised so that it is in a vertical orientation, as shown in FIG. 3A, i.e. at an angle of 90° to the horizontal, the sensor element 12 is moved downwards maximally by its weight force or by gravity contrary to the spring force of the spring element 14.

By monitoring the position and displacement of the sensor element 12, the orientation of the operating element 2 or a change in the orientation can thus be determined using the sensor 11.

The bearing device is configured to allow the user to set a basic position of the operating element 2 and to move the operating element 2 for this purpose. In so doing, the user can also alter the orientation of the operating element 2 and optimally adapt it to his or her ergonomic requirements or comfort requirements. By means of the sensor 11, the control unit 8 senses the initial position or home position of the operating element 2 set by the user. By means of the sensor 7, the control unit 8 senses an operation or actuation of the operating element 2, through which the operating element 2 can be moved in operation and/or be exposed to an actuating force.

The control unit 8 is in particular configured to adjust a braking characteristic in order to optimally determine a braking request as a function of the driver's sensed actuation of the operating element 2 in the initial position of the operating element 2. If, for example, the operating element is unfavorable from an ergonomic point of view or is unfavorably oriented, the actuation force sensed by the sensor 7 is increased or reduced by the control unit 8 in order to achieve an optimal braking result. The exact orientation of the operating element 2 may also be used for other purposes, for example for adjusting an acceleration characteristic.

The control unit 8 is also preferably connected to the actuator 9 to control said actuator so that it exercises one or more pulses of force on the operating element 2. Typically, the actuator 9 is controlled to provide haptic feedback to the driver to inform them of travel situations, such as employing an ABS control or the like. The control unit 8 preferably also controls the actuator 9 to apply one or more pulses of force, in particular in the form of a predetermined vibration, to the operating element 2 during a calibration of the control device 10 in order to precisely determine the orientation of the operating element 2. The pulses of force cause the sensor element 12 to be moved out of its rest position, as indicated by a double arrow 16 in FIGS. 3A to 3C, whereby the sensor 11 is excited and the orientation of the operating element 2 can thus be reliably and precisely sensed. In particular, by applying one or more pulses of force to the operating element 2, measurement errors when determining the orientation of the operating element are ruled out.

Preferably, the sensed orientation is subjected to a plausibility check using information from the motor vehicle that is in particular already present in the motor vehicle in any case, for example, information about the orientation of the motor vehicle with respect to a horizontal plane. For example, an inclined position of the overall motor vehicle can be considered when checking the plausibility of the orientation of the operating element 2 and compensated for accordingly. In particular, an inertial sensor is used for this purpose, which is typically already installed in the motor vehicle and serves as a further sensor or reference sensor. As a result, the orientation of the operating element 2 sensed by the sensor 11 is compensated for by the actual orientation of the motor vehicle 1 and thus the orientation of the operating element 2 with respect to the motor vehicle 1 is reliably determined.

Optionally, the control unit 8 is also configured to determine a braking request not depending on the orientation of the operating element 2 in its initial position as well as the sensed actuation, but also depending on further information, for example, via the one seat setting, a steering wheel setting, the weight of a driver of the vehicle, images of an interior camera or a driver profile. This may advantageously make it possible to adjust a braking characteristic and/or an acceleration characteristic.

What is claimed is:

1. A setting device for sensing a driving request for a motor vehicle comprising:
an operating element configured to be actuated by a driver of the motor vehicle, wherein
a first sensor is associated with the operating element and configured to sense an actuation acting on the operating element,
the operating element is arranged such that it is displaceable by a bearing device in different idle positions, and
a second sensor is associated with the operating element and configured to sense a current orientation of the operating element.

2. The setting device according to claim 1, wherein the second sensor is an accelerometer.

3. The setting device according to claim 1, wherein the operating element is assigned at least one controllable actuator which is controllable to apply a force to the operating element to perform a verification of the current orientation sensed by the second sensor.

4. The setting device according to claim 3, wherein the at least one controllable actuator is configured as a vibration actuator.

5. The setting device according to claim 1, wherein a control unit is specifically designed to sense a current orientation of the operating element when used as intended, depending on a signal of the second sensor.

6. The setting device according to claim 5, wherein the control unit is specifically designed to control at least one controllable actuator to perform a verification of the sensed current orientation when used as intended.

7. The setting device according to claim 5, wherein the control unit is specifically designed to correct an actuating force sensed by the first sensor or an actuating path sensed by the first sensor depending on an orientation of the operating element sensed by the second sensor.

8. The setting device according to claim 1, wherein the operating element is configured as a foot pedal or handle.

9. The setting device according to claim 5, wherein the control unit is configured to conduct a plausibility check of an orientation of the operating element sensed by the second sensor depending on a sensor signal of at least one further sensor.

10. A motor vehicle having a setting device according to claim 1.

11. A method for operating a setting device according to claim 1 wherein a current orientation of the operating element is determined as a function of a sensor signal of the second sensor.

12. The method according to claim 11, wherein a driving request of a driver of the motor vehicle is determined as a function of the determined current orientation and a sensor signal of the first sensor.

13. A method for operating a motor vehicle according to claim 10, wherein a current orientation of the operating element is determined as a function of a sensor signal of the second sensor.
